(19) United States
(12) Patent Application Publication
(10) Pub. No.: US 2005/0120318 A1
(43) Pub. Date: Jun. 2, 2005

(54) Apparatus and method for designing semiconductor integrated circuit

(75) Inventors: Hiroki Goko, Tokyo (JP); Junichi Tamura, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 10/813,031

(22) Filed: Mar. 31, 2004

(30) Foreign Application Priority Data
Nov. 28, 2003 (JP) 2003-399900

(51) Int. Cl. G06F 9/45; G06F 17/50

(52) U.S. Cl. 716/6; 716/10; 713/500

(57) ABSTRACT

The present invention provides an apparatus for designing a semiconductor integrated circuit, which is capable of satisfying timing constraints without providing BFBs, and improving a convergent property at optimization, and a design method therefor. An LSI automatic design simulator (10) determines the number of clocks employed in a clock generating functional part (30) and delays in respective clocks, allocates the clocks set as clock systems, and verifies constraint conditions with respect to design, based on the respective clocks. A tree determining functional part (32) adjusts skews of the respective clocks through the use of the produced cock systems, makes delay adjustments to the clocks, verifies a layout adjustment, and fetches therein data supplied thereto without timing constraint violation, thereby making it possible to further enhance a convergent property that satisfies all of timing constraints.

### BACKGROUND OF THE INVENTION

1. Field of the Invention

The present invention relates to an apparatus for designing a semiconductor integrated circuit and a design method therefor. The apparatus for designing the semiconductor integrated circuit, according to the present invention relates to, for example, a design simulator for verifying whether constraints on circuit and layout designs are satisfied. The method of designing the semiconductor integrated circuit, according to the present invention relates particularly to a design method for verifying whether timing constraints on a circuit design, a layout design and both of them are satisfied.

This application is counterpart of Japanese patent application, Serial Number 399900/2003, filed Nov. 28, 2003, the subject matter of which is incorporated herein by reference.

2. Description of the Related Art

The design of a semiconductor integrated circuit is divided roughly into two of a circuit design and a layout design. When the circuit design is carried out, the description of functions corresponding to the specs of the semiconductor integrated circuit and a logic combining constraint file based on timing specs is created. A logic combinable RTL (Register Transfer Level), which is one of abstract levels where hardware is descried in language, has been widely used in the description of the functions corresponding to the circuit specs. The created constrained file includes an ideal clock cycle, a clock delay, a skew, etc. Here, the clock delay means a delay from an input port to, for example, each of flip-flop circuits.

Next, the optimization of logic combination/timing and hold assurance are performed on the basis of the constrained file. Thereafter, a timing analysis of the semiconductor integrated circuit is performed using the ideal clock. When the analytical result does not satisfy timing constraints (timing constraint violation), the timing's optimization is carried out until the timing constraints are satisfied, to perform re-combination, after which a timing analysis based on the ideal clock is repeated. When the timing constraints are satisfied, a gage level net list is obtained. Thus, the circuit design is ended.

The layout design corresponding to another factor at the design of the semiconductor integrated circuit performs the creation of a floor plan on the basis of the size of the gate level net list obtained with the circuit design. Thereafter, circuit's respective blocks are laid out. Then, the creation of clock trees and a skew adjustment are carried out. The skew adjustment is performed in such a manner that actual clock skews fall within a skew range of the ideal clock defined in a constrained file. After the skew adjustment, respective cells that satisfy timing constraints are laid out and wired (timing-driven layout).

Here, the timing-driven layout includes even hold assurance.

Next, a timing analysis in which actual clock delays have been built therein, is carried out. When the result thereof does not satisfy timing constraints, the process of the timing-driven layout in the semiconductor integrated circuit is performed. Timings are analyzed again under the condition obtained by this process to thereby verify whether timing constraints are satisfied. The timing-driven layout and the timing analysis are repeated until the timing constraints are satisfied. The processing is repeated in this way, so that layout data about the semiconductor integrated circuit is obtained which has satisfied the timing constraints.

Patent Document 1:

Japanese Laid Open Patent No. 2001-332693

Meanwhile, the timing constraints included in the constrained file are uniformly equal and applied to all of data paths. The data path means a path at a logic portion between respective flip-flops. Thus, since the timing constraints are uniform, a timing constraint is strict in terms of a long data path and the convergence of constraint verification becomes difficult. In such a case, timing constraint violation might occur at the combination stage. Due to the occurrence, the number of man-hours at the timing optimization will increase. Since the timing constraints are not achieved as the case may be, the semiconductor integrated circuit had no other choice but to change its specs.

A method of designing a buffer circuit and a semiconductor integrated circuit device using it, according to the Patent Document 1 comprises registering into a circuit library, a delay adjustment block group which includes an input unit, a delay adjustment unit and an output unit and wherein such a configuration as to hold constant drive capacities containing at least block's input/output terminal positions, outer shapes and outer dimensions, an input terminal capacity and dependence of the output unit on the load and to change only signal delay values of the delay adjustment unit in a predetermined range is provided with a plurality of BFBs (Buffer Blocks) in which only the signal delay values are caused to change, and inserting the BFBs into necessary signal paths, thereby making it possible to replace them with BFBs different in signal delay value without exerting an influence on design even after layout completion, and doing delay simulation without its reattempt. In the semiconductor integrated circuit, however, BFBs are provided as extra configurations in signal paths upon execution of delay adjustments.

### SUMMARY OF THE INVENTION

The present invention aims to solve the drawbacks of such a prior art and provide an apparatus for designing a semiconductor integrated circuit, which is capable of satisfying timing constraints and improving a convergent property at optimization, and a design method therefor.

According to one aspect of the present invention, there is provided an apparatus for designing a semiconductor integrated circuit, comprising:
a first design functional block that performs a circuit design on the semiconductor integrated circuit and verifies constraint conditions with respect to the circuit design; and
a second design functional block that performs a layout design on the semiconductor integrated circuit and verifies constraint conditions with respect to the layout design,
wherein the first design functional block includes a clock generating functional block that determines the number of stepwise-delayed clocks used for the verification, determines delays among the respective clocks, generates the respective clocks corresponding to the number thereof as clock systems and allocates the clock delays, and
the second design functional block includes a system determining functional block that generates clock systems, adjusts skews of respective clocks and adjusts clock delays of the clock systems.

The semiconductor integrated circuit design apparatus of the present invention determines the number of clocks used in the clock generating functional block of the first design functional block and clock delays in the clocks, allocates the respective clocks defined as clock systems, verifies constraint conditions for design, based on the respective clocks, and takes or fetches therein supplied data without timing constraint violation. This indicates that a list that satisfies all of timing constraints has been obtained. The system determining functional block of the second design functional block adjusts skews of the respective clocks, using the produced clock systems, further performs clock delay adjustments and verifies layout adjustments, thereby making it possible to shorten a convergent time interval required to satisfy all the timing constraints upon circuit and layout designs as compared with the prior art.

According to another aspect of the present invention, there is provided a method of designing a semiconductor integrated circuit, comprising the following steps:
a first step for determining the number of clocks different in delay amount, which are used for verification of a circuit design of the semiconductor integrated circuit upon the circuit design thereof and determining delays in the clocks on the basis of set conditions for constraints of timings;
a second step for allocating clocks supplied to respective circuits; and
a third step for optimizing the timings on the basis of a list obtained by the timing constraint conditions and the clock allocation and determining whether results of analyses of the respective timings correspond to violation of the constraints,
wherein the optimization of the timings is repeated according to the constraint violation.

The semiconductor integrated circuit design method of the present invention determines the number of clocks different in delay amount and clock delays in the clocks, allocates the respective clocks supplied to respective circuits, determines whether results of analyses of respective timings, which are carried out with the timing optimization, correspond to constraint violation, and repeats the timing optimization according to the violation, thereby making it possible to speed up convergence up to satisfaction of all the timing constraints as compared with the prior art.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a block diagram showing a schematic configuration of an LSI automatic design simulator to which an apparatus for designing a semiconductor integrated circuit, according to the present invention is applied;

FIG. 2 is a main flowchart for describing the operation of the LSI automatic design simulator shown in FIG. 1;

FIG. 3 is a flowchart for describing the operation of a circuit design routine in the main flowchart shown in FIG. 2;

FIG. 4 is a flowchart for describing the operation of a layout design routine in the main flowchart shown in FIG. 2;

FIG. 5 is a diagram for describing the relationship between clock systems and respective paths;

FIG. 6 is a diagram for describing input timings of the clock systems and respective data;

FIG. 7 is a timing chart for describing a condition for selecting a clock supplied to each flip-flop circuit;

FIG. 8 is a flowchart for describing an improvement in the operation of the circuit design routine shown in FIG. 3; and

FIG. 9 is a flowchart for describing an improvement in the operation of the layout design routine shown in FIG. 4.

### DETAILED DESCRIPTION OF THE INVENTION

Preferred embodiments of the present invention will hereinafter be described with reference to the accompanying drawings.

One embodiment of an apparatus for designing a semiconductor integrated circuit, according to the present invention will next be described in detail with reference to the accompanying drawings.

The present embodiment shows an LSI (large-Scale Integration) automatic design simulator 10 to which the apparatus according to the present invention is applied. A diagrammatic illustration of portions irrelevant directly to the present invention and the description thereof will be omitted. In the following description, signals are designated at reference numerals for connecting lines illustrated in the description.

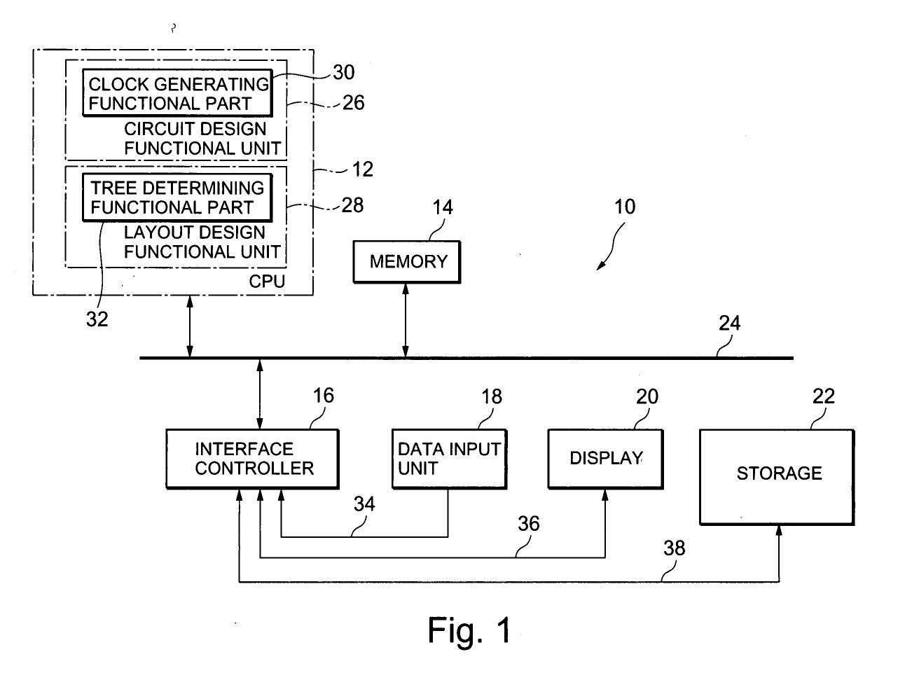

As shown in FIG. 1, the LSI automatic design simulator 10 includes a CPU (Central Processing Unit) 12, a memory 14, an interface controller 16, a data input unit 18, a display 20 and a storage 22. In the LSI automatic design simulator 10, the CPU 12, the memory 14 and the interface controller 16 make use of a bus 24 to perform the transfer of data and control signals thereamong.

The CPU 12 includes a circuit design functional unit 26 which sequentially reads programs used in LSI design and performs their computations so as to meet input conditions supplied from outside to thereby design an LSI-based circuit, and a layout design functional unit 28 for determining a layout design. The circuit design functional unit 26 includes a clock generating functional part 30 for generating a plurality of types of clocks. Further, the clock generating functional part 30 has the function of determining even mutual differences in delay among the clocks on the basis of the respective rates of the generated clocks.

The layout design functional unit 28 includes a tree determining functional part 32 for determining the number of clock trees to be generated, and the function of determining differences in delay among the clock trees.

The memory 14 is equipped with an SDRAM (Synchronous Dynamic Random Access Memory) and a memory controller although they are not illustrated in the figure. The memory controller controls a memory area of the SDRAM, operating timings thereof, etc.

The data input unit 18, the display 20 and the storage 22 are connected to the interface controller 16. The interface controller 16 is connected to the bus 24. The interface controller 16 is provided with, for example, a PCI (Peripheral Component Interconnect) bus controller although it is not shown in the figure. An interface control part such as a keyboard, a mouse or the like, a display controller, an IDE (Integrated Device Electronics) controller and an SCSI (Small Computer System Interface) corresponding to the data input unit 18, the display 20 and the storage 22 respectively are connected to the PCI bus controller. The PCI bus controller transmits data supplied from the peripheral devices to the bus 24 and supplies the data to the CPU 12 and the memory 14 via the bus 24.

The data input unit 18 includes the keyboard, the mouse, a modem for taking in or fetching data via external communications, etc. The display 20 has the function of visually displaying conditions such as specs for a circuit design, input conditions related to a wiring allocation, and layouts based on a computational result, etc. under such conditions.

The storage 22 is a hard disk drive or a RAID (Redundant Arrays of Inexpensive Disk) device. The storage 22 stores therein various information used in circuit and layout designs and saves finally-obtained circuit pattern data therein. As the various information, may be mentioned, for example, a net list indicative of the relationship of connections between logical circuits, cell libraries used in cell and macro designs, and a program for executing a functional logic design, etc.

The circuit design program and layout design program held in the storage 22 configured in this way are sequentially read into the CPU 12, where whether or not they match with spec conditions and timing constraints or the like is computed to thereby perform simulation for an LSI design under these conditions.

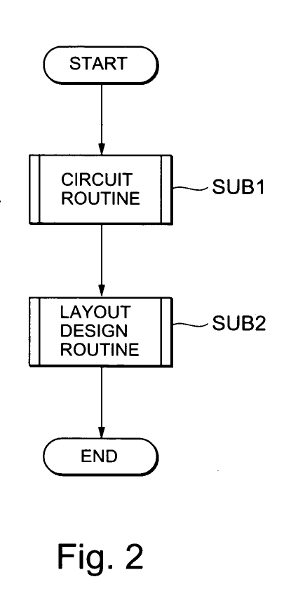

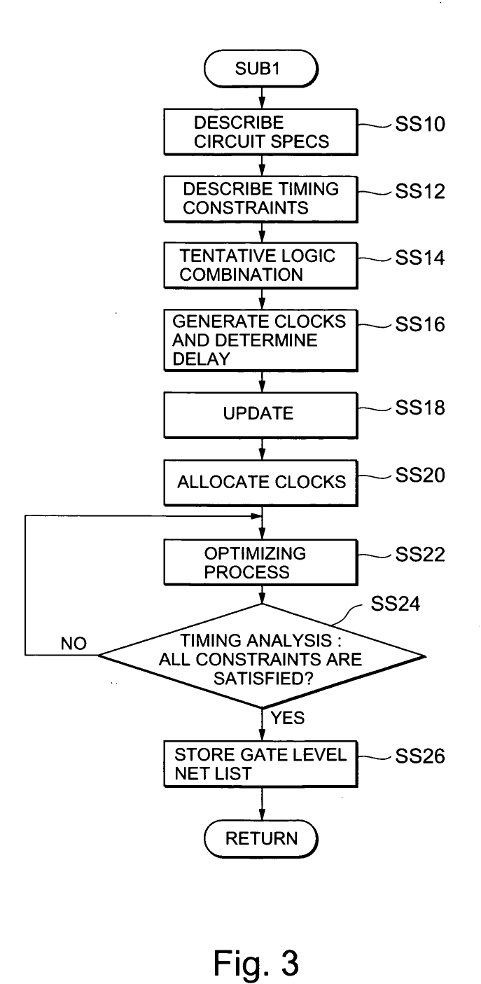

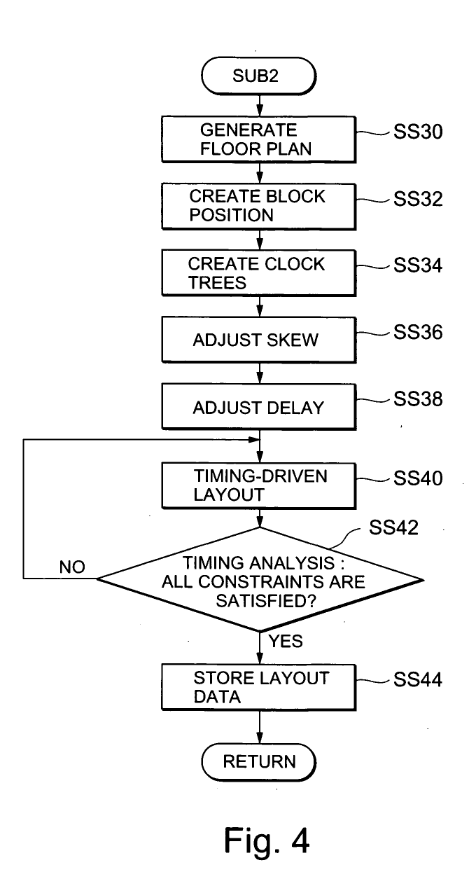

The operation of the LSI automatic design simulator 10 will next be explained. As shown in FIG. 2, the LSI automatic design simulator 10 basically has a circuit design routine (SUB1) and a layout design routine (SUB2) and performs a layout design on the basis of the circuit design. The respective routines will be explained in further detail with reference to FIGS. 3 and 4 shown in a subsequent stage.

As shown in FIG. 3, the circuit design routine (SUB1) describes specifications or specs of a circuit (sub step SS10). An RTL language is used in the description of the specs. Timing constraints will next be described (sub step SS12). These descriptions are fetched into the LSI automatic design simulator 10 on the basis of the data input unit 18 as conditions. The data input unit 18 transmits the fetched data 34 to the interface controller 16. The interface controller 16 supplies it to the memory 14 via the bus 24 or supplies, for example, restricted or constrained file data 38 with timing constraint conditions described therein to the storage 22. Also the interface controller 16 sends the supplied data 34 to the display 20 as data 36 and displays the data on the screen of the display 20.

Next, the circuit design functional unit 26 reads a constrained file from the memory 14 or the storage 22 and performs a tentative logic combining process on the basis of timing constraints (sub step SS14). Owing to this process, paths in the circuit can be classified. That is, the paths are divided or classified according to whether an allowance is made for the timing constraints. Described specifically, a decision as to the classification is made on the basis of a slack value based on a timing report relative to a circuit obtained by a tentative logic combination. The slack value indicates the difference between the time required to set up or hold input data prescribed in each flip-flop (Flip-Flop: FF) circuit and the time necessary for achievement of actually input data. When the slack value is positive, such a value part is indicative of having allowance for timing constraints. When the slack value is negative, only such a value part is indicative of acting against or violating the timing constraints.

The clock generating functional part 30 determines the number of clock trees generated according to the layout design on the bases of the slack value (sub step SS16). Further, the clock generating functional part 30 also determines clock delay differences mutually developed among the respective generated clock trees. Each clock delay difference is determined according to the result of the timing report.

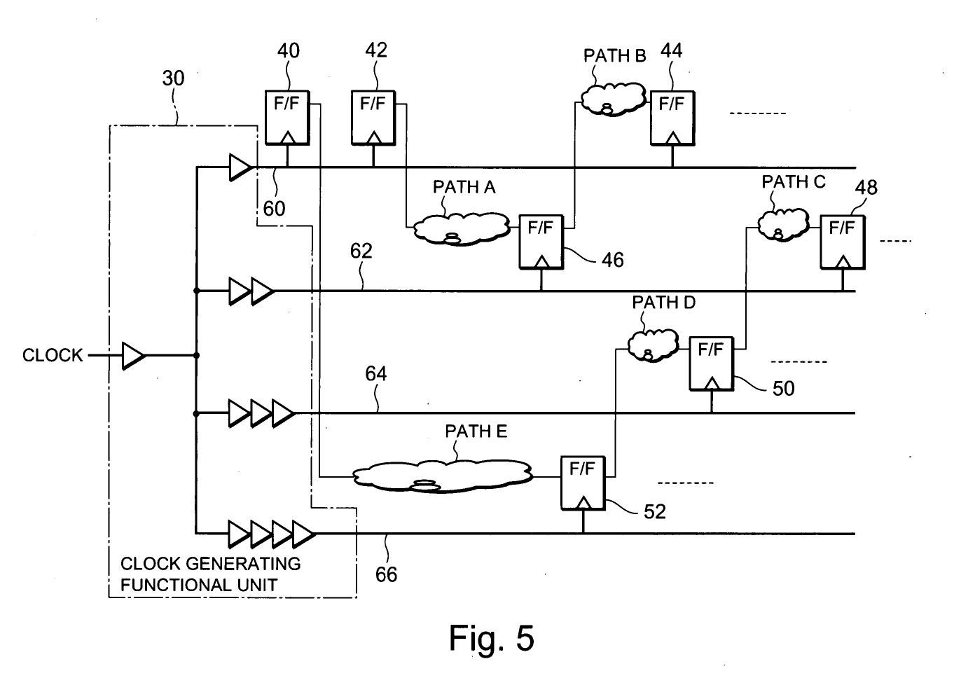

Next, the respective generated clock trees are defined and the generated constrained file is updated and recorded in the storage 22 (sub step SS18). The clock generating functional part 30 allocates a clock to each of the flip-flop circuits (sub step SS20). Described specifically, the same clock is supplied to all of the flip-flop circuits in a gate level net list obtained by the logic combination done according to the tentative logic combining process. The clock allocation intends to re-connect to the respective clock trees in each of which the supply of the clock is defined. The clock generating functional part 30 shown in FIG. 5 indicates the state of execution of the clock allocation. Owing to the utilization of the clocks different in delay in combination, the clock generating functional part 30 is capable of setting constraints on different timings to data buses lying among the respective flip-flop circuits in the circuit to be designed.

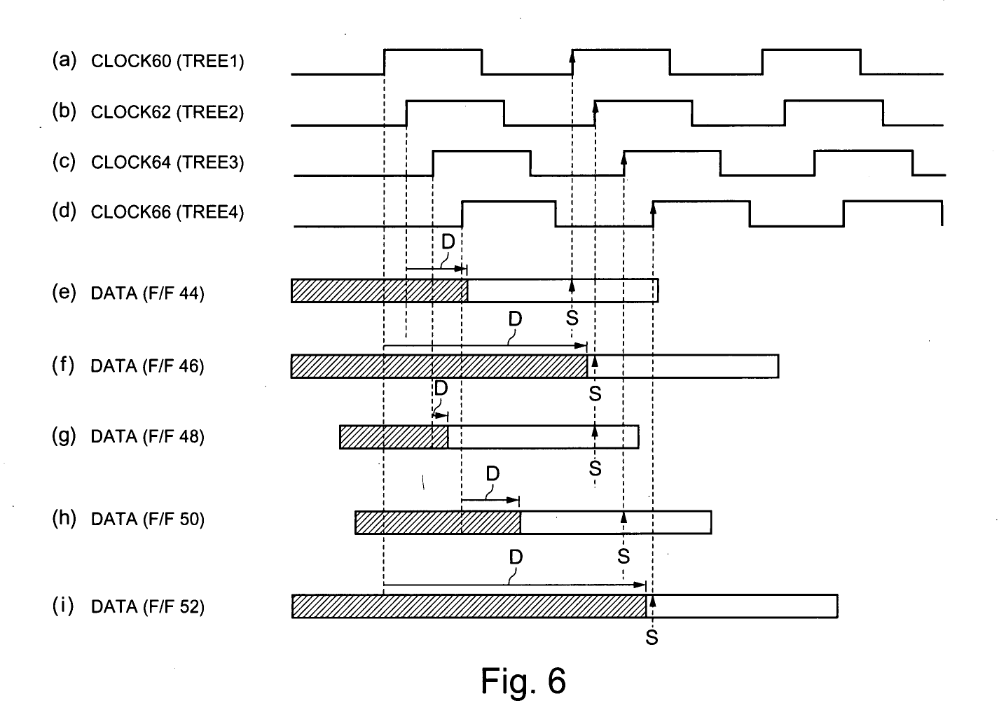

Referring to FIG. 5, flip-flop circuits 40 through 52 are respectively connected via paths. Let's assume that the length of each path is proportional to the magnitude of each of paths A through E employed in the present embodiment. The amount of each delay will be examined based on the present assumption. As a result, it is understood that the path E placed between the flip-flop circuit 40 and the flip-flop circuit 52 is large. Thus, when the same clock is supplied to the flip-flop circuit 52, timing constraints become strict in terms of satisfaction. In the clock generating functional part 30 employed in the present embodiment, buffers are connected to branches equivalent to brogs of systematic trees supplied with clocks so as to differ from one another in multistage form. Thus, the clock generating functional part 30 generates four types of clocks 60 through 66 and supplies these clocks according to the lengths of the paths. Here, the clocks 60 through 66 correspond to trees 1 through 4 and are shown in FIGS. 6(a) through 6(d), respectively.

As shown in FIG. 5, the flip-flop circuit 40 corresponds to a data starting point and is operated by the supplied clock 60 of the tree 1. When the flip-flop circuit 52 is activated by the clock 66 larger in delay amount than the clock 60 due to the fact that a delay amount D is large as shown in FIG. 6(i), a delay due to the path E is canceled out by a delay in clock. This means that a delay time interval allowed for the path E from the flip-flop circuit 40 to the flip-flop circuit 52 increases. Thus, the flip-flop circuit 52 is capable of avoiding constraint violation of timing used in the present circuit at the stage of a tentative logic combining process regardless of the fact that the position to fetch or capture data, i.e., a sampling position S is placed in a hatching area indicative of the constraint violation.

A description has been made of the path E largest in delay amount. However, even in the case of the respective paths of the flip-flop circuits 42 through 50, the flip-flop circuits are respectively capable of avoiding timing's constraint violation by being supplied with clocks having delay amounts proportional to delays in the paths with respect to the reference clock as shown in FIGS. 6(e) through 6(h).

The flip-flop circuit 44 that samples data from the flip-flop circuit 46 via the path B has sufficient allowance for a timing constraint. In this case, the flip-flop circuit 44 may use the clock 60 (tree 1) smaller in delay amount than the clock 62 (tree 2) supplied to the flip-flop circuit 46 as shown in FIG. 6(e). Thus, although the delay time allowed for the path B lying between the flip-flop circuit 46 and the flip-flop circuit 44 becomes small, no timing constraint violation occurs.

Thus, it is preferable to use a clock set as small in delay amount as possible as the clock supplied to the corresponding flip-flop circuit on the fetching side of data, where the path having allowance for the timing constraint exists. When the path strict in timing constraint exists in the next stage or later, the clock large in delay amount can be used.

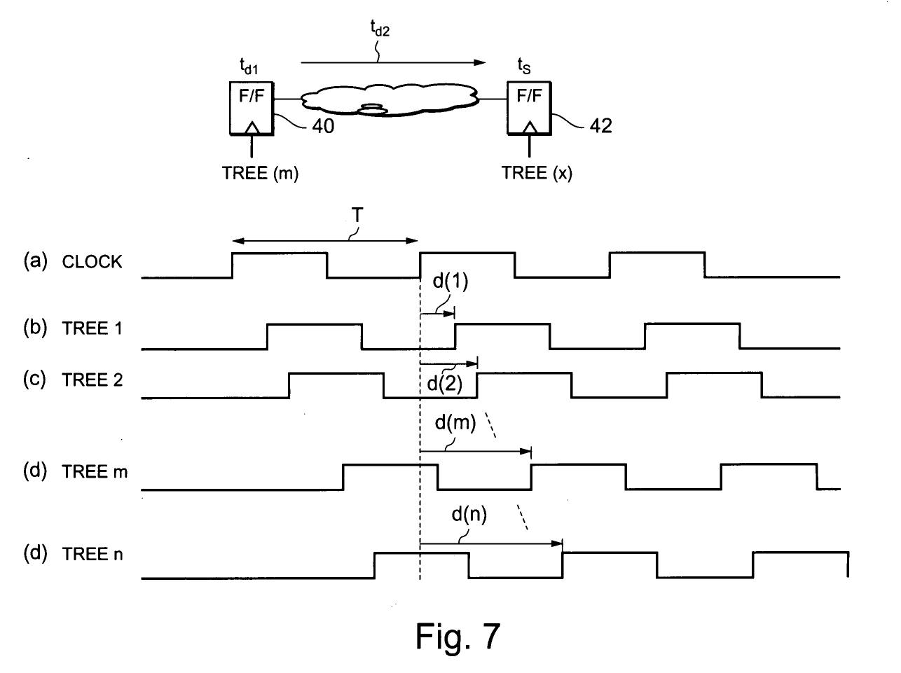

The selection of each clock will be explained here. The clock generating functional part 30 determines the number of clock trees as n. One cycle of a clock to be used is defined as T. The respective clock trees are respectively defined as a tree 1, a tree 2, . . . , a tree n as shown in FIGS. 7(b) through 7(e), and clock delays of the respective trees are respectively defined as d(1), d(2), . . . , d(n). Delay amounts of the clock trees are in proportion with an increase in n ((d(x)<d(x+1), 1≦x≦n)).

An internal data delay of the flip-flop circuit 40 is set as td1, a delay due to a path lying between the flip-flop circuit 40 and the flip-flop circuit 42 is set as td2, a setup time defined with respect to the flip-flop circuit 42 per se is set as ts, and a clock used in the flip-flop circuit 40 is set as a tree m, respectively. A clock shown in FIG. 7(a) will be examined as the reference. At this time, the delay amount d(x) of the flip-flop circuit 42 is expressed as follows:
d(x)>td1+td2+ts+d(m)−T (1)
The minimum number of clock delay stages x that satisfies this expression is selected. The clock delay is set in advance in this way.

Referring back to FIG. 3, the process of optimizing timing by re-combination on the basis of the constraint of updated timing and a laid-out gate level net list after the completion of clock allocation is performed (sub step SS22). The optimizing process performs even hold assurance.

A timing analysis is performed on the basis of constraints on updated timings and n generated clocks (trees) (sub step SS24). When the analytical result does not satisfy all of the timing constraints (the answer is found to be NO), the routine is returned to the optimizing process (sub step SS22), where the timing optimization by re-combination is performed. That is, it is repeated until the timing constraints are all satisfied. When the timing constraints are all satisfied (the answer is found to be YES), a gate level net list that has satisfied the conditions is obtained (generation/storage of gate level net list: sub step SS26). The display 20 displays the generated gate level net list as a circuit diagram, for example. The circuit design functional unit 26 stores the obtained gate level net list in the storage 22 and proceeds to return, where the procedure of the circuit design is ended.

The layout design (SUB2) will next be described. First, the layout design functional unit 28 generates a layout-based floor plan (sub step SS30). Subsequently to it, the layout design functional unit 28 creates a block layout or arrangement (sub step SS32). The procedures or procedural steps used up to now are identical to conventional ones. Next, the tree determining functional part 32 creates clock trees (sub step SS34). As to the clock trees, clocks generated by the circuit design as described above are produced in several. Skews are respectively matched with target values every next-generated clocks (sub step SS36). Next, a delay developed between the respective adjacent clocks is adjusted so as to match with the corresponding clock delay (sub step SS16) determined by the circuit design routine (SUB1) (delay adjustment: sub step SS38).

After the clock adjustment, a timing-driven layout process is performed (sub step SS40). After the completion of such a process, a timing analysis based on a propagation clock is performed to thereby make a decision as to whether all of timing constraints are satisfied (sub step SS42). When all the timing constraints are not satisfied (the answer is found to be NO), the routine is returned to the timing-driven layout process and such a layout process is repeated. When all the timing constraints are satisfied (the answer is found to be YES), the routine proceeds to the process of generating layout data (sub step SS44).

The layout design functional unit 28 outputs layout data that satisfied all of the timing constraints to the bus 24 and stores it in the storage 22 via the interface controller 16 (sub step SS44). The interface controller 16 supplies the obtained layout data to the display 20 where it is displayed thereon. The layout design functional unit 28 proceeds to return, where the procedure for the layout design is finished.

Owing to the operation being executed in the above-described manner, the timing analysis is performed using the plural clocks even in the layout design to make a decision as to whether violation of timing constraints has occurred, thereby making it possible to obtain layout design that has satisfied all constraints.

According to the circuit design and the layout design, the number of the clock trees and the differences in delay among the respective clock trees are determined from the result of the timing analysis on the gate level net list of the tentative logic combination result. Further, the clock tree that satisfies the sampling timing of each flip-flop circuit is selected and used. Therefore, the logic combination, which has been executed by uniformly placing the same timing constraint on the logic paths, results in a logic combination to which constraints on the timings corresponding to the lengths of the paths are applied. Applying the individual timing constraints and combining them makes it possible to relax a corresponding path strict with respect to timing constraints from the early stage of the circuit design and to obtain a semiconductor integrated circuit that satisfies a higher operating speed as compared with the normal circuit design.

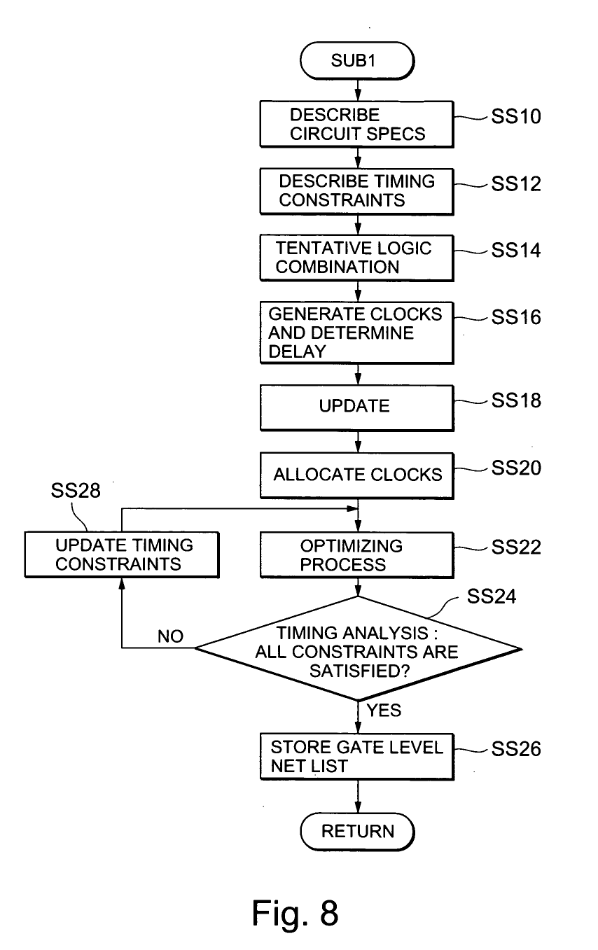

The operation of a circuit design routine (SUB1) will be explained again using FIG. 8. The same procedural steps as those shown in FIG. 3 are respectively identified by the same reference numerals, and their description will be omitted to avoid cumbersomeness of their description. The procedure of the present embodiment executes a timing analysis (sub step SS24). When the result thereof shows timing constraint violation (the answer is found to be NO), the timing constraint is changed and an updating process is carried out again (sub step SS28).

Described more specifically, the value of a clock delay difference is adjusted again based on the result of actual timing optimization (sub step SS28). After its adjustment, the routine procedure proceeds to the optimizing process (sub step SS22). The optimizing process is performed as described above. In the re-optimizing process, only hold assurance is executed when no timing constraint violation occurs, and a gate level net list may be obtained.

By reviewing each adjusted value related to the delay in clock in this way, a high timing convergent property can be obtained at the stage of the circuit design.

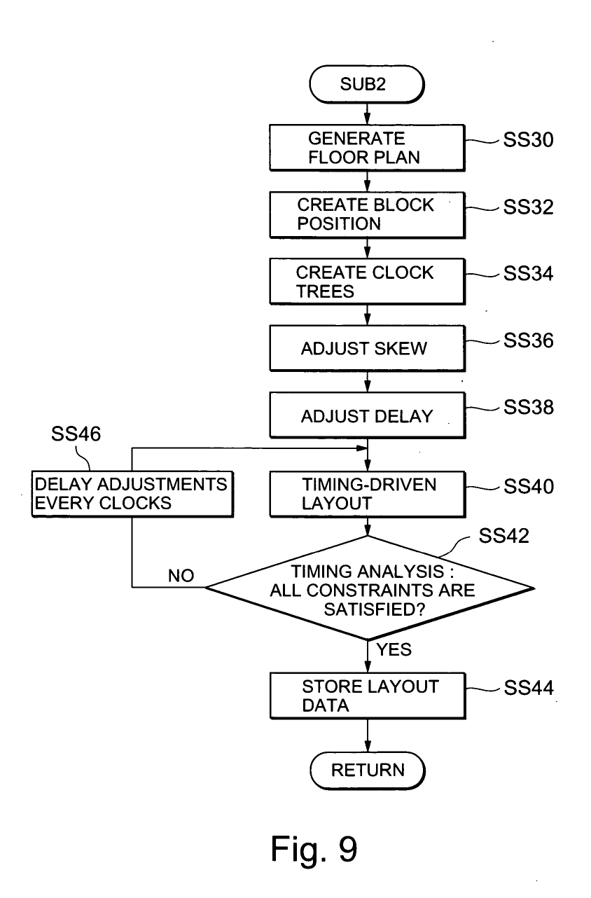

The operation of a layout design routine (SUB2) will be explained using FIG. 9. The same procedural steps as those shown in FIG. 4 are respectively identified by the same reference numerals, and their description will be omitted to avoid cumbersomeness of their description. The procedure of the present embodiment executes a timing analysis (sub step SS42). When the result thereof shows timing constraint violation (the answer is found to be NO), delays set every clocks are adjusted (sub step SS46). By performing such delay adjustments, assurance is made to hold violation that appears newly. After such adjustments, the routine returns to a timing-driven layout process (to sub step SS40), and this process is repeated.

Thus, a higher timing convergent property can be obtained even in the case of the layout design.

Incidentally, it is apparent that when both additional processes of the circuit design and the layout design are set so as to be included, a much higher timing convergent property can be obtained.

Owing to the configuration made in the above-described manner, the number of clocks used in the clock generating functional part 30 of the circuit design functional unit 26, and delays in the clocks are respectively determined. Then the clocks set as clock systems are respectively allocated and design's constraint conditions are verified based on the clocks. Further, supplied data are fetched or captured without any timing constraint violation, whereby a list that satisfies all the timing constraints is determined. The tree determining functional part 32 of the layout design functional unit 28 adjusts skews of the respective clocks by using the produced clock systems and performs clock's delay adjustments to thereby verify layout adjustments, whereby a convergent time interval required to satisfy all the timing constraints upon the circuit design and layout design can be shortened as compared with the prior art.

The clock generating functional part 30 adds an internal delay in a flip-flop circuit corresponding to a data's output starting point, a setup time of a flip-flop circuit corresponding to each data supply destination, a delay developed with each of paths among flip-flop circuits, and a delay of a clock supplied to the flip-flop circuit corresponding to the output starting point, and determines a clock delay allocated based on the difference between the added value and the cycle of the clock, thereby making it possible to use the minimum clock tree and avoid timing constraint violation.

The method of designing the semiconductor integrated circuit determines the number of clocks different in delay amount from one another and delays in clocks, allocates clocks supplied to respective circuits thereto respectively, makes a decision as to whether results of analyses of respective timings, which are carried out with the timing optimization, correspond to constraint violation, and repeats timing optimization according to the violation, thereby making it possible to speed up convergence up to satisfaction of all the timing constraints as compared with the prior art.

Upon the layout design of a semiconductor integrated circuit, clocks different in delay amount are respectively generated for verification of the layout design, skews are adjusted every different clocks, each of delays respectively contained in the clocks is adjusted to the determined clock delay, an adjustment to such a layout that timing constraint conditions are satisfied is made, whether results of analyses of respective timings correspond to constraint violation is determined, and the layout adjustment is repeated according to the constraint violation. Thus, even in this case, a convergent time interval taken up to satisfaction of all of timing constraints can be made shorter than ever.

When it is found that constraint violation occurs in the results of timing analyses under the circuit design routine, the value of a clock delay is adjusted again according to the violation so that an adjusted value is reviewed, whereby much higher timing convergence can be brought about under this routine.

When it is found that constraint violation occurs in the results of timing analyses under the layout design routine, delays set every clocks are adjusted according to the violation, thereby making it possible to bring about much higher timing convergence under this routine.

Each allocated clock delay is determined by adding an internal delay at a starting point where data is outputted, a setup time interval, a delay developed due to each path and a delay in clock to be used and using the difference between the added value and the cycle of the clock, whereby the minimum clock tree can be used and timing constraint violation can be avoided.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is therefore contemplated that the appended claims will cover any such modifications or embodiments as fall within the true scope of the invention.

1. A method of designing a semiconductor integrated circuit, comprising the following steps:
a first step for determining the number of clocks different in delay amount, which are used for verification of a circuit design of the semiconductor integrated circuit upon the circuit design thereof and determining delays in the clocks on the basis of pre-set conditions for constraints of timings;
a second step for allocating clocks supplied to respective circuits; and
a third step for optimizing the timings on the basis of a list obtained by the timing constraint conditions and the clock allocation and determining whether results of analyses of the respective timings correspond to violation of the constraints,
wherein the optimization of the timings is repeated according to the constraint violation.

2. A method according to claim 1, further comprising the steps:
a fourth step for generating the clocks different in the delay amount for the verification of a layout design of the semiconductor integrated circuit upon the layout design thereof;
a fifth step for adjusting skews every said different clocks;
a sixth step for adjusting delays respectively included in the clocks to the determined clock delays upon the layout design, respectively; and
a seventh step for making an adjustment to a layout that satisfies the timing constraint conditions upon the layout design and determining whether analytical results of the respective timings correspond to the constraint violation,
wherein the layout adjustment is repeated according to the constraint violation.

3. A method according to claim 1, further comprising an eighth step for adjusting the value of each of the clock delays again according to the constraint violation when the constraint violation exists in the third step.

4. A method according to claim 1, further comprising a ninth step for adjusting delays set every said clocks according to the constraint violation when the constraint violation occurs in the seventh step.

5. A method according to claim 1, which adds a delay taken up to the output of data at a starting point where the data is outputted, a time interval required to set up the data, a delay developed with a path between respective circuits and a delay in the clock to be used, and determines the allocated clock delays according to the difference between the added value and the cycle of the clock.
